(19) United States
(12) Patent Application Publication
(10) Pub. No.: US 2006/0004699 A1
(43) Pub. Date: Jan. 5, 2006

(54) Method and system for managing metadata

(75) Inventors: Juha Lehikoinen, Lakiala (FI); IIkka Salminen, Tampere (FI); Pertti Huuskonen, Tempere (FI); Timo Sorsa, Helsinki (FI); Harri Lakkala, Tampere (FI); Tero Hakala, Kangasala (FI)

Correspondence Address: BANNER & WITCOFF, 1001 G STREET N W, SUITE 1100, WASHINGTON, DC, 20001, US

(73) Assignee: NOKIA Corporation, Espoo (FI)

(21) Appl. No.: 10/880,428

(22) Filed: Jun. 30, 2004

(51) Int. Cl. G06F 7/00

(52) U.S. Cl. 707/2

(57) ABSTRACT

Methods and systems for managing metadata are described. The method comprises steps of receiving a request from an application to access a metadata attribute corresponding to a piece of content, determining whether the application is authorized to access the metadata attribute, retrieving the metadata attribute upon determining that the application is authorized to access the metadata attribute, and transmitting the metadata attribute to the application. A metadata storage medium may be accessed and searched for the metadata attribute. The metadata storage medium may be encrypted to provide additional security.

### FIELD OF THE INVENTION

The invention relates to user content management. More particularly, the invention relates to systems and methods for processing requests for information associated with user content.

### BACKGROUND OF THE INVENTION

Uses for mobile devices continue to evolve. Today, a mobile phone has capabilities to capture still pictures, capture video sequences, send messages, send image files, send text messages, maintain contact information, and connect to the Internet. To handle all of the features, mobile devices require more memory. Available memory in mobile devices will shortly reach gigabyte levels. With the ease of data capture and transfer, there will be hundreds if not thousands of video clips and still images in any given mobile device. The amount of stored content increases even more when the images and video clips can be sent to other users. Editing images and creating new films and multimedia presentations has become a norm. However, the input capabilities of a mobile device will always be somewhat limited (e.g., a dozen or so buttons).

There are numerous problems when utilizing metadata. One problem relates to the semantics of a metadata attribute. The creator of a painting is the actual painter. However, the creator of a song is vague. The creator of a song may be the artist, the composer, the producer, or the arranger. When the object that the metadata describes is a part of another object, e.g., a song that belongs to the soundtrack of a movie, the semantics of the metadata attribute is even more difficult. Determining the most appropriate semantic of each metadata attribute to allow application writers to use the metadata and to allow the metadata being converted from a format to another has become more important.

Another problem in dealing with metadata is input of descriptive information. Today, it is not realistic to assume that a user will manually annotate her content to a large extent. A user taking various pictures with a digital camera will often fail to input any information to describe the content, other than a title for each picture when saving the digital photos. As a result, there is a need for automatic creation of as much metadata about a piece of content as possible.

Still another problem with utilizing metadata is the ability to search for personal content. For example, a user sends a text document to a friend, describing potential directions for their vacation planned for next summer. A few months later, the user cannot find the document anywhere. She may not remember the name of the file or the location in the folder structure. The user cannot track documents sent during a particular time or to a particular person.

Currently, some metadata is collected by computing systems, such as mobile phones and personal computer (PCs). As an example, a mobile phone keeps track of sent messages, including whom the message was sent to, what the type of the message was, and what the date of sending was. A problem with this collection is that all media items that are included in the process cannot be referenced to at a later time. For example, the user is not able to open an image to see the people that the image has been sent even though the underlying information exists.

There is no standard way to maintain metadata. How metadata is managed depends on the media type, format of the object, or just how an application developer preferred to implement it into the application. In addition, metadata is usually stored inside the objects themselves, i.e., the metadata is embedded into the object. With the additional embedded information, the size of the object increases and the ability to edit or read the metadata is more difficult. Further, because one is embedding the metadata into the object, there is a compromise in privacy. Metadata may be sensitive or private and it is exposed to misuse when it is embedded inside the content object.

In the simplest form, metadata management systems merely display the metadata related to a media object in a plain text-based list. Some advanced systems include a screen to visualize metadata or to interact with single metadata items. However, there is no system that creates metadata-based relations between two content objects and brings that relation information to the user.

### BRIEF SUMMARY OF THE INVENTION

It would be an advancement in the art to provide a method and system for managing metadata.

According to aspects of the present invention, a request from an application to access a metadata attribute corresponding to a piece of content is received and a determination is made as to whether the application is authorized to access the metadata attribute. The requested metadata attribute is retrieved upon determining that the application is authorized to access the metadata attribute, and the requested metadata attribute is then transmitted to the application.

Another aspect of the present invention includes a metadata storage medium that may be accessed and searched for the metadata attribute. Still another aspect allows the metadata storage medium to be encrypted to provide additional security.

Another aspect of the present invention includes a terminal device for managing metadata including separating content object form corresponding metadata attributes. Still another aspect of the present invention provides a user interface configures to indicate when new relation information about a content object is received by a terminal device.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a block diagram of an illustrative model for utilizing personal content in accordance with at least one aspect of the present invention;

FIG. 2 is a functional block diagram of an illustrative electronic device that may be used in accordance with at least one aspect of the present invention;

FIG. 3 illustrates a block diagram of an illustrative system for processing metadata in accordance with at least one aspect of the present invention;

FIG. 4 illustrates a block diagram of an illustrative system for processing metadata in accordance with at least one aspect of the present invention;

FIG. 5 illustrates a system for processing requests for metadata information in accordance with at least one aspect of the present invention;

FIG. 6 illustrates a block diagram of illustrative entries in a storage medium in accordance with at least one aspect of the present invention;

FIG. 7 illustrates a flowchart for processing a request to process metadata in accordance with at least one aspect of the present invention; and

FIGS. 8A and 8B illustrate schematic displays on a terminal device in accordance with at least one aspect of the present invention.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

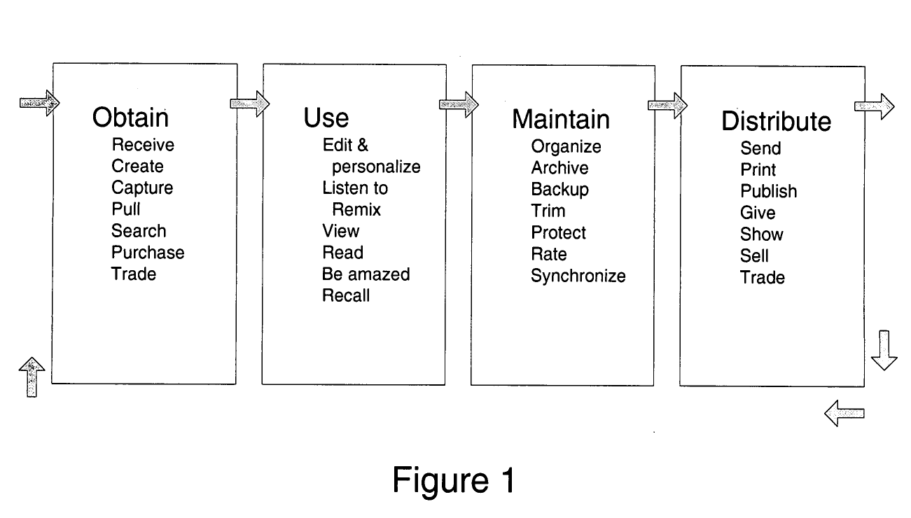

FIG. 1 is an illustrative model for utilizing personal content. FIG. 1 illustrates the lifecycle of personal content usage. First, the user obtains the content from somewhere. Some examples are shown in FIG. 1, including the user receiving a file, accessing a file, contacting a file, contacting a person, capturing a still image, and purchasing a file. Next, the user can use the content while at the same time maintain it (more or less). For example, as shown the user can edit and personalize the content, view the content, and/or listen to the content. For maintaining the content, the user can organize the content, achieve the content, and backup the content for storage. Finally, some pieces of content may be distributed by sending, publishing, and selling the content. Thereafter, the shared piece of content will continue its lifecycle in some other device.

Personal content may be described as any digital content targeted at human sensing that is meaningful to the user, and is controlled or owned by the user. This includes self-created content in addition to content received from others, downloaded, or ripped. One aspect for maintaining efficient content management is metadata. The term “metadata” is not unambiguous. What may be data for some application may be metadata for some other. For example, the call log in a mobile phone is data for a log application, while it is metadata for a phonebook application. As used herein, the term metadata describes all information that provides information of a content object. It is structured information about some object, usually a media object. It describes the properties of the object. For example, with respect to a document created on a word processing application, the document itself is the content object; while the authors of the document are a part of the metadata of the content object (other parts include the number of words, the template used to create the document, the date of the last save, etc.). Metadata is used to organize and manage media objects. For instance, if there are hundreds of documents and pictures, metadata may be used to find, sort, and handle the large number of files.

In addition to metadata that directly describes content, there is also metadata that is indirectly related to the object. For example, the person that a user sends an image to is a part of the metadata of the image. In such a case, the metadata is also a content object itself; therefore, metadata creates a relation between these two objects.

Each individual piece of metadata is referred to as a metadata attribute. As an example, a digital photo might be the content object, all information describing the image is its metadata, and the color depth is a metadata attribute. There are many examples of metadata. Some types are direct single data items, such as the bit rate of a video stream. Metadata is not limited to such cases. A thumbnail image of a digital photo is also metadata, as is the fact that the song “ABC.MP3” is part of a collection entitled “My Favorite Songs”.

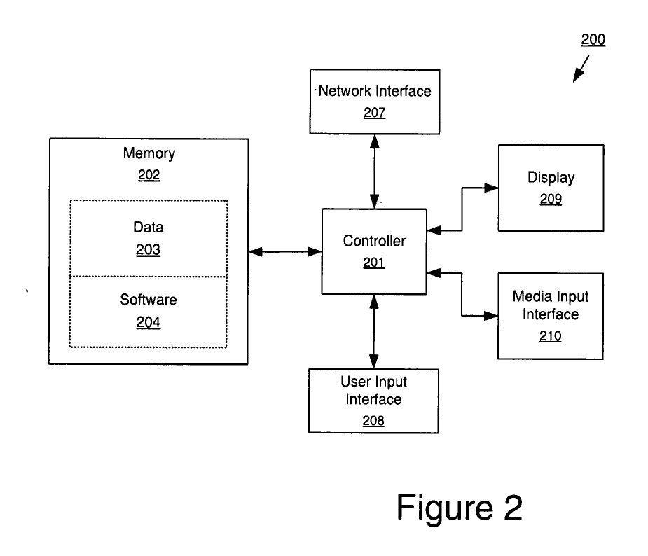

FIG. 2 is a functional block diagram of an illustrative computer 200. The computer 200 may be, or be part of, any type of electronic device, such as a personal computer, personal digital assistant (PDA), cellular telephone, digital camera, digital camcorder, digital audio player, GPS device, personal training/fitness monitoring device, television, set-top box, personal video recorder, watch, and/or any combination or subcombination of these, such as a camera/phone/personal digital assistant (PDA). The electronic device may be a mobile device, which is a device that can wirelessly communicate with base stations and/or other mobile devices. The computer 200 of the electronic device may include a controller 201 that controls the operation of the computer 200. The controller 201 may be any type of controller such as a microprocessor or central processing unit (CPU). The controller 201 may be responsible for manipulating and processing data, for executing software programs, and/or for controlling input and output operations from and to the electronic device. The controller 201 may be coupled with memory 202, one or more network interfaces 207, a user input interface 208, a display 209, and/or a media input interface 210.

The network interface 207 may allow for data and/or other information to be received into, and/or to be sent out of, the electronic device. For example, data files may be sent from one electronic device to another. Where the electronic device is a mobile device, the network interface 207 may be a wireless interface, such as a radio frequency and/or infra-red interface. Where the electronic device is a non-mobile device, the network interface 207, if one exists, may be a wired interface such as an Ethernet or universal serial bus (USB) interface. In a mobile device, the network interface 207 might include only a wireless interface or both a wireless interface and a wired interface.

The user input interface 208 may be any type of input interface, such as one or more buttons (e.g., in the form of a keyboard or telephone keypad), one or more switches, a touch-sensitive pad (which may be transparently integrated into the display 209), one or more rotatable dials, and/or a microphone for voice recognition.

The display 209 may be any type of display, including but not limited to a liquid crystal display (LCD), a light-emitting diode (LED) display, an organic-LED (OLED) display, a plasma display, and/or an LCD projector. The display 209 may be physically divided into one or more displayable portions, and may include one or more display screens and/or one or more individual indicators such as status lights.

The media or other input interface 210 may provide media data (i.e., audio, video, text, monitoring data, and/or still images) to the computer 200. The media or other input interface 210 may include or be coupled to media input devices, e.g., a microphone, a still image camera, a video camera, and/or one or more sensor devices, such as a thermometer, altimeter, barometer, pedometer, blood pressure apparatus, electrocardiograph, and blood sugar apparatus. The processor 201 may store such media data in one or more media files in the memory 202. The processor 201 may further cause media data to be displayed on the display 209, be output to a speaker, and/or to be sent out of the electronic device (e.g., to other electronic devices) via the network interface 207. Media data, which may be in the form of media files, may also be received (e.g., from other electronic devices) by the computer 200 via the network interface 207.

The memory 202 may be any type of memory such as a random access memory (RAM) and/or a read-only memory (ROM). The memory 202 may be permanent to the electronic device (such as a memory chip on a circuit board) or may be user-changeable (such as a removable memory card or memory stick). Other types of storage may be alternatively or additionally used, such as a hard disk drive, flash memory, etc. The memory 202 may store a variety of information useful to the electronic device, such as software 204 and/or data 203. The software 204 may include one or more operating systems and/or applications. The data 203 may include data about the electronic device, user files, and/or system files. For example, media files may be stored in the data 203 portion of the memory 202. Although the memory 202 is shown as being divided into separate portions in FIG. 2, this is merely shown as a functional division for explanatory purposes. The memory 202 may or may not be divided into separate portions as desired. Data, such as media files, may further be stored external to the electronic device such as on a different electronic device and/or on a network. In this case, the memory 202 may be considered to include such external storage.

In accordance with another aspect of the present invention, a central service in a terminal device and/or a server is provided for managing metadata; therefore the metadata can be used in a standard way in all applications. Methods and systems are provided for protecting the metadata from unauthorized usage. Methods and systems are provided for extracting and creating the metadata. Methods and systems are provided for collecting and storing the metadata. The metadata management and storage system separates the metadata from the objects it describes. The metadata management and storage system provides a unified service to all applications utilizing metadata. It also provides a single control point to all metadata and increases the data protection. The system may be a piece of software that resides inside the terminal device and/or server. It provides the applications in the terminal device and/or server with unified access to the metadata, ensuring that only authored software is permitted.

The metadata management system includes three parts. First, an API for applications is used to query and store metadata. Applications can also subscribe to be notified about changes in metadata. Second, a control point or GateKeeper component checks if an application has rights to know about or access the metadata they are querying. Third, a storage system stores all kind of metadata with links to the object that the metadata describes. The links may be local or external, i.e., the object that the metadata describes does not need to be stored in the same terminal device and/or server. Metadata may be stored in an encrypted form in the database, making it useless for unauthored applications if accessed. The same metadata item can describe several objects. Objects may not be physically stored in the same place as metadata items.

The client API may have three functions. A GetMetadata( ) function gets a metadata item from the management system. This function has a condition or filter (e.g., file name) as a parameter and the system returns all metadata matching the criteria. A SetMetadata( ) function stores the metadata item into storage. This function has the metadata item and the object identifier as parameters. The system stores the metadata item and attaches it to the object. A SubscribeToChange( ) function asks the system to notify the application when a given metadata changes, or when metadata of a given file changes. This function may have the same parameters as the GetMetadata( ) function. When the metadata matching the criteria changes, the application is notified and given the changed metadata.

The GateKeeper component may be a Symbian-type server. All client API calls go through the GateKeeper component. The GateKeeper component checks that the calling application has sufficient rights before using the storage system to retrieve or store the metadata. If a metadata item is changed by the SetMetadata( ) call, the GateKeeper component notifies all applications that have subscribed to changes. The storage system may be a Symbian-type server with its own database or another data management system. The database may be encrypted only allowing the GateKeeper component to call the storage system and decrypt the metadata. The storage system may store all events and metadata items.

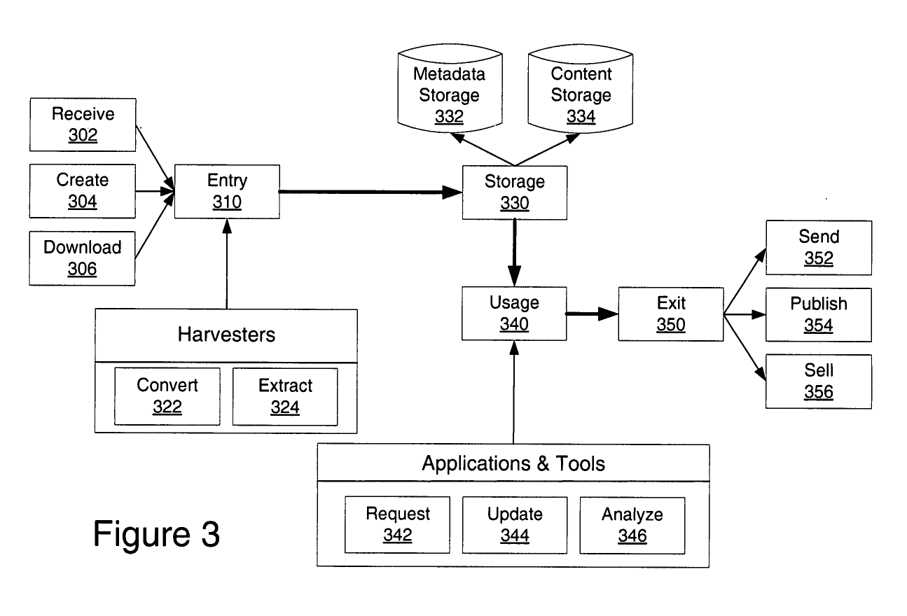

In accordance with at least one aspect of the present invention, a model for the metadata management and storage system consists of an entry point, a storage point, a usage point, and an exit point. Such an illustrative model is shown in FIG. 3. Upon arriving 310 into a user's device, such as a mobile telephone, a piece of content is examined for metadata. For example, the piece of content may originate because the user received 302 the content, because she created 304 the content, or because she downloaded 306 the content. The examination may be conducted by a conversion system 322 and/or an extraction system 324. The examination of the piece of content may be based on extraction for known metadata formats or it may be a brute-force extraction method from the whole object. Further, the examination may include feature recognition, such as identifying faces in an image. Once the metadata is extracted, it is stored 330. The metadata is stored separately from the objects itself; any preexisting metadata already embedded within the object may not be separated from the object. The metadata is stored in a metadata storage system 332 and the content of the object is stored in a content storage system 334. In accordance with at least one aspect of the present invention the metadata storage system 332 may be in a different device than the content storage system 334. For example, metadata storage system 332 may reside in a network server and the content storage systems 334 may reside in a plurality of different devices.

When an application has requested metadata for some type of use 340, the access rights of the application with respect to the metadata are examined. Only applications that are authorized to access the desired piece of metadata are allowed access to it. Whenever the user interacts with the content object, the interactions are stored as metadata. Further, different engines can further process the metadata, e.g., to create associations that may be stored as metadata. Illustrative applications seeking to use metadata include requesting 342 metadata, updating 344 metadata, and analyzing 346 metadata. Finally, once the user shares 350 a piece of content, the metadata privacy attributes are checked. Information of the shared pieces or content, such as to/with whom the content is shared and when the content is shared, may also be stored as metadata. Some metadata attributes that are marked as shareable may be embedded in the object upon exit 350, while other metadata may be kept private. Examples of how a user may share include sending 352 the piece of content, publishing 354 the piece of content, and selling 356 the piece of content.

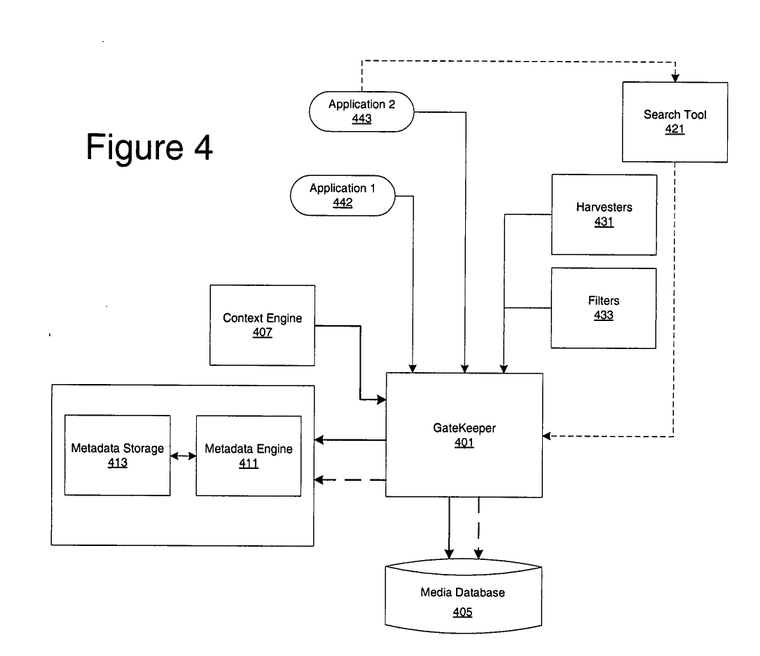

In accordance with one aspect of the present invention, the architecture of the metadata management and storage system includes a GateKeeper 401, a metadata engine 411, a search tool 421, a metadata database 413, harvesters 431, filters 433, and a context engine 407 as illustrated in FIG. 4. The GateKeeper 401 acts as a safeguard between the stored metadata in the metadata storage 413 and applications 442 and 443. The GateKeeper 401 provides applications 442 and 443 with access to the metadata according to their access rights. The GateKeeper 401 may also allow or deny storing of metadata and/or a piece of content. Metadata engine 411 takes care of all actions with the stored metadata. It provides interfaces for storing, requesting, and subscribing to changes in metadata. Search tool 421 is a cross-application tool that provides search functionality. Metadata database 413 is a relational database that contains the metadata attributes for each content object. Harvesters 431 are a set of system-level software components that analyze content with different methods, such as feature recognition and text extraction, and that store the results as a set of metadata. Filters 433 are a type of harvester that extracts known metadata formats from content, such as EXIF from images. Finally, context engine 407 provides applications 442 and 443 and the system with information of the current context.

The harvesters 431 and filters 433 extract the metadata from content objects as the content objects arrive. In accordance with at least one aspect of the present invention, the harvesting may also be timed. For example, the harvesters 431 may be launched when a terminal device is idle and charging. The harvesters 431 may search for existing metadata formats within objects or they may be used to analyze the object and create new metadata entries. Harvesters 431 may extract metadata based on a known metadata format directly from the content object or they may perform brute-force text extraction. Harvesters 431 may reside in a remote area. In these cases, the content is sent for analysis to a remote network server with the harvesters and the filters, which then harvests the metadata and returns the results.

Once extracted, the metadata is stored in a database 413, separately from the content objects in the media database 405. The separation allows for an increase in security so that private metadata will not be accessible and/or changed. Alternatively, the separation allows for many or all user of a system to access the metadata. Along with metadata, the metadata and storage system stores references to the actual objects. The references may be URIs used to identify the location of the content object. The actual object may be stored locally, in server, or it may be a movie on a DVD disc, or music on a portable storage medium that cannot be accessed at all by the terminal device. Instead of having static fields in a database, each attribute is stored as a property. For example, the attribute name and value may be stored. In a database, both the name and value are character strings and the actual data type of the value is described in the metadata ontology. Once new metadata attributes are introduced, no changes in the table are required; they may be stored in the table as any other metadata. This also allows applications to specify their own proprietary metadata attributes.

Metadata stored in the database can be used in many ways. It may be accessed by applications 442 and 443 that need to process it some way, e.g., to show to the user. The metadata also may be used by tools that process it in order to make associations, relations, or categorizations. Further, metadata may be updated or augmented by many applications, thereby, creating new metadata in the form of histories, such as a superlog including interaction history and a contextlog with context snapshots.

It should be understood by those skilled in the art that aspects of the present invention may be utilized entirely within a terminal device, such as a cellular phone and/or a personal digital assistant (PDA) of a user, may be utilized entirely within a server, and/or may be utilized within a system that includes a terminal device and a server where certain aspects are performed within the terminal device and certain aspects are performed within the server. The present invention is not so limited to the illustrative examples described within the Figures.

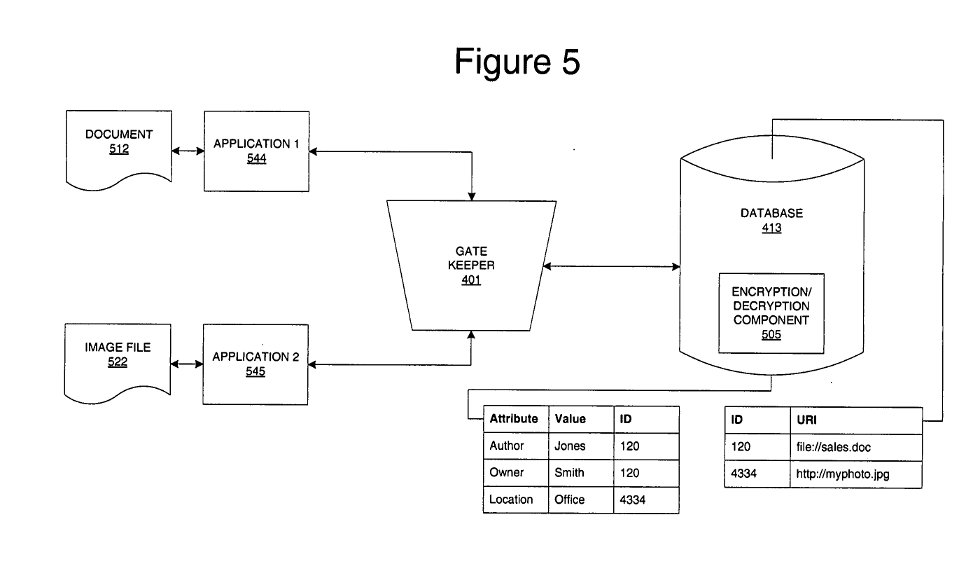

FIG. 5 illustrates an example of two different applications 544 and 545 requesting access to metadata in accordance with at least one aspect of the present invention. Application 1 544 receives a document 512. Application 2 545 receives an image file 522. When the applications or tools request access to metadata, they contact the GateKeeper component 401. The GateKeeper component 401 verifies the access rights of the requesting application 544 and 545 and provides the application with metadata that it is allowed to access. The GateKeeper component 401 uses the metadata engine to retrieve the metadata from the metadata database 413 and to filter unauthorized metadata out. In the first example, Application 1 544 requests the GateKeeper component 401 for the “Author” metadata for document “sales.doc”. The GateKeeper component 401 determines whether the Application 1 544 has access rights. In this case, Application 1 544 is authorized to access the “Author” metadata so the GateKeeper component 401 retrieves from the storage database 413 the items that describe the “sales.doc” and then gets the value of the “Author” property, decrypts it using the encryption/decryption component 505 and sends it back to Application 1 544. In another example, Application 2 545 request the GateKeeper component 401 for the “Location” metadata for remote picture http://mypic.jpg. The GateKeeper component 401 determines that Application 2 545 has no rights for the requested metadata attribute, so the GateKeeper component 401 does not fulfill the request of Application 2 545.

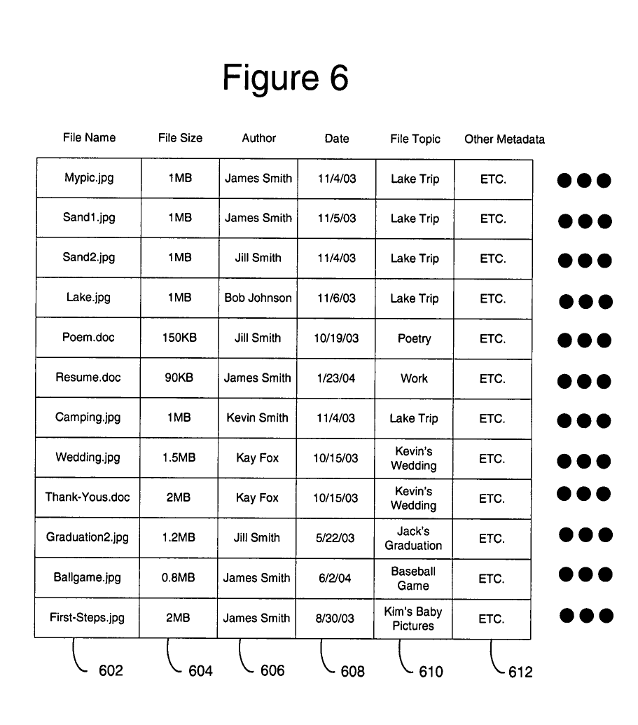

FIG. 6 illustrates a block diagram of illustrative entries in a storage database 413 in accordance with at least one aspect of the present invention. Metadata of various types and information are shown. For example, column 602 is a listing of the file names stored in the storage database 413. Column 604 is a listing of the file size for each respective file. Column 606 is a listing of the author metadata attribute and/or an originating device metadata attribute for each respective entry. Column 608 is a listing of the date the metadata was saved to the storage database 413. Column 610 is a listing of the topic describing the file and column 612 is a listing of other metadata attributes, such as how many times the file has been accessed and/or by whom and when the file has been accessed, how many times a particular metadata attribute has been accessed and/or by whom and when the particular metadata attribute has been accessed, how many times the file has been delivered and/or by whom and to whom and when the file has been delivered, how many times a particular metadata attribute has been delivered and/or by whom and to whom and when the particular metadata attribute has been delivered, and when the last time the metadata information for a file was changed and/or by whom and when the last time the metadata information for the file was changed. It should be understood by those skilled in the art that the present invention is not limited to the entry configuration and/or metadata entries shown in FIG. 6.

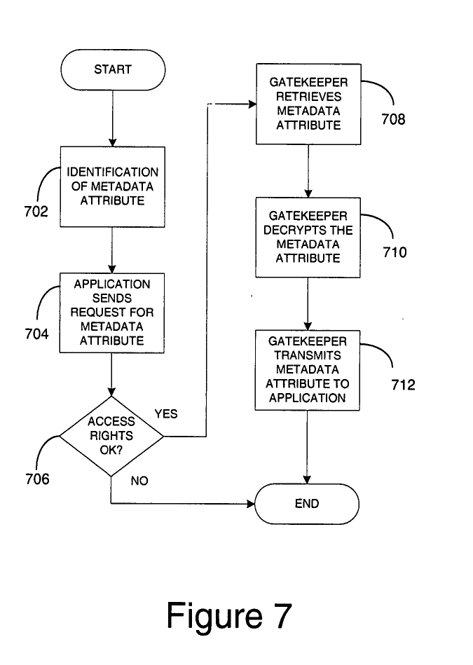

FIG. 7 illustrates a flowchart for processing a request to process metadata in accordance with at least one aspect of the present invention. The process starts and proceeds to step 702 where the metadata attribute of interest to the user is identified by the application. At step 704, the application sends a request for the metadata attribute of interest to the GateKeeper component. The process then proceeds to step 706 where a determination is made as to whether the application requesting the metadata is authorized to access the requested metadata. For example, if the metadata attribute requested is private, the GateKeeper component may determine that the requesting application has no access rights to the metadata attribute requested or the metadata at all. If the determination is that the application has no access rights, the process ends and the GateKeeper may inform the application that the requested metadata attribute is restricted from the application. If the application does have access rights, the process proceeds to step 708.

At step 708, the GateKeeper retrieves the requested metadata attribute. The process continues to step 710 where the GateKeeper component decrypts the metadata attribute before sending the requested metadata attribute to the requesting application. Alternatively, the storage database maintaining the metadata attributes may be configured to decrypt the requested metadata attribute before sending it to the GateKeeper component. At step 712, the GateKeeper component transmits the decrypted metadata attribute to the requesting application. Alternatively, the GateKeeper component may encrypt the metadata attribute before sending the requested metadata attribute to the requesting application.

Once a request for a metadata attribute has been received and the GateKeeper component can search the metadata in the metadata storage database. Searching is one activity that benefits from accurate and descriptive metadata. Accurately tagged content objects can be searched for based on their metadata. Metadata extracted by the means of a feature recognition method also may be used as a means of searching for the actual content, not just its metadata. As a result, the user receives more accurate results with less effort. In addition to basic searching, however, metadata may also contribute indirectly. For example, metadata can automatically provide created profiles and preferences. This information can be used for prioritizing search results and for filtering.

In accordance with one aspect of the present invention, metadata ties different content types together, i.e., the relations between content objects themselves. The ability to link people with files and time provides a more powerful searching capability in terms of versatility and comprehension. Metadata also allows for limited proactive searching, such as for a calendar. The calendar entries, together with the relevant content objects, may be used as a basis for searching for more information on the same topic. This information is readily available for accessing once the actual event takes place.

Metadata provides several benefits to a user in content management. Metadata may be used as a basis for automatic content organization, such as creating automated playlists or photo albums. Examples of criterion include, “Show me all photos that contain one or more persons”, and “I want to listen to 10 music tracks in my collection that I have listened to on an earlier weekends”. This allows for creating automated new collections dynamically.

Metadata can also help in tracing content history or a lifecycle. “When and where did I get this photo?” and “when was the last time I accessed this file?” are typical questions in tracing content. Furthermore, the relations between objects help build an overall view of the history, not just that of a single content object. Metadata can be used to recreate a past event by collecting all relevant objects, and presenting them as a multimedia collage of the event.

A method for automatically collecting metadata that is related to a user's interaction with content is described in accordance with at least one aspect of the present invention. In one embodiment, a metadata-enabled access system provides access to metadata content while preserving memory size in the content object and privacy for metadata that is not open to the public. Aspects of the present invention are based on a system-level component that is used by all applications. This system-level component may be a message-delivery system that can be used by applications to inform others of the status of the application. For example, when an image is opened in an application, the application may inform the overall system that image xyz.jpg has been opened. This application provides information. Then, any other application that is interested in some or all of this information can use the information the best way the other application sees fit. This other application consumes information.

One type of information consumer is a superlog system. Whenever any application, such as an imaging application, a messaging application, or any other application, informs that the user has interacted with a certain content object, the superlog system stores this information for future use. The information stored by the superlog system can then be exploited by any other information provider. For example, a software component may be used that can find associations between people and files. This software component uses the information stored by the superlog system in order to create the associations.

Implementation of a superlog system may consist of three parts: the information consumer that collects the events and stores them, the actual data storage for the events, and the information provider that creates the associations between the stored objects. The data storage may be implemented as a table in a relational database inside a terminal device and/or server. Such a table may contain the following information:

TABLE 1
Superlog Data Storage Table

TIMESTAMP: the time of the event
OBJECT_ID: an identifier to the relevant content object (which is stored
elsewhere in the database or in the file system)
ACTION: an enumerated code for the action (e.g., 1=saved,
2=opened, etc.)
ACTOR: an identifier of the application that created the event
PEOPLE: a list of people associated with this event (may be NULL;
the IDs are pointers to the phonebook data table)

Applications use the superlog by making database queries. These database queries may be SQL queries to the superlog database, but there is no need to expose the end user to SQL. The applications will create the queries based on a user action. For example, a user uses a phonebook application to display all documents that were sent to a friend. The phonebook application performs a SQL query searching all records where the ACTION parameter has a code for “sent” and the PEOPLE parameter contains the phonebook entry ID for the friend. The result of the query may be then formatted to fit the needs of the application and, if needed, further filtered using timestamp or actor fields.

In accordance with at least one aspect of the present invention, a superlog system for automatically collecting metadata that can help in managing the growing amount of personal content stored in terminals and other devices is provided. The superlog system enables very versatile formation of different relations between objects, applications, people, and time, thus providing several different ways of accessing the content.

A superlog system stores the action of a user with content objects. Whenever an action is performed, e.g., save, send, or receive, a log entry is created for the event. The log entry contains a reference to the content object, a timestamp, an indication of the type of the action, and a reference to a contextlog. The superlog system may also store any related people or contacts. The superlog system may not store all interactions. It allows a user to access a brief interaction history of an object, to find related people, and to query the context at the time of the action. This information can further be used to form more complex associations between objects, people, and contexts.

A contextlog system is used to store a snapshot of the current context. It stores relevant information that is related to the current state of the user, the device, or the environment. This may include information such as battery strength, currently opened applications, or weather information. Together with the superlog system, these two logs allow for greater flexibility in creating associations between personal content.

Because the metadata is stored separate from the objects, security for restricting access is increased. The metadata and objects may be stored in a database. A database offers several benefits over a traditional file system, such as indexing, built-in means of synchronization and back-up, and efficient access control. The database may be local or remote.

In accordance with at least one aspect of the present invention, a system for visualizing, accessing, and interacting with metadata-based relations between media objects is provided. The system consists of a method for storing the relations and a user interface for accessing and controlling them. The relations may be created manually by a user (e.g., “This photo relates to this piece of music”), or the relations may be created automatically. Automatic creation may occur responsive to another action, such as sending a message, or automatic creation may be a result of a process launched to search for associations between media items.

The components of a system for visualizing, accessing, and interacting with metadata-based relations between media objects include a visualization component, an access component, and an interaction component. The visualization component provides a means to inform the user that a certain media item has some relations attached to it. Different relations may be visualized in different ways. Further, the visualization component displays the state of the relation, such as whether it is new or already checked. The access component provides a means to easily access media objects that are related to the object that is currently focused. The interaction component allows the user to manipulate the relations, such as removing them, creating them manually, and verifying them.

Aspects of the visualization component include the novelty of the information, i.e., has the user viewed an automatically created relation or not, and the freshness of the information, i.e., how long ago was the relation discovered. Furthermore, the visualization component must differentiate between automatically and manually created relations, as well as with different types of relations. Optional parts of the visualization component may include, e.g., the importance pf the information, i.e., how important the objects in the relation are.

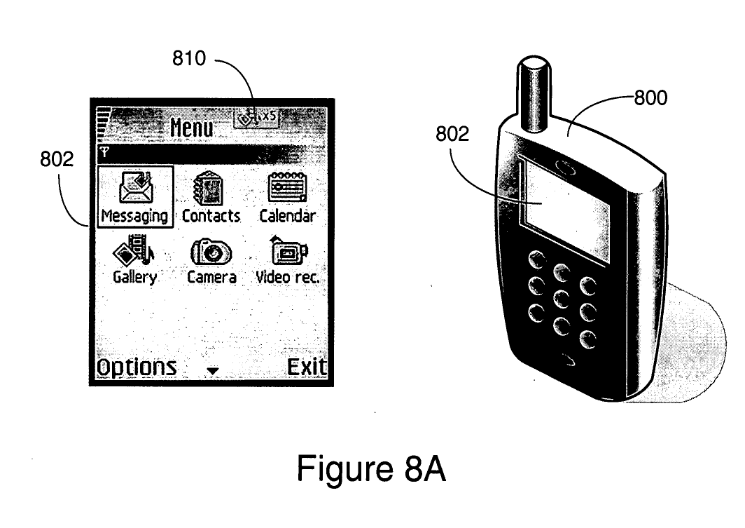

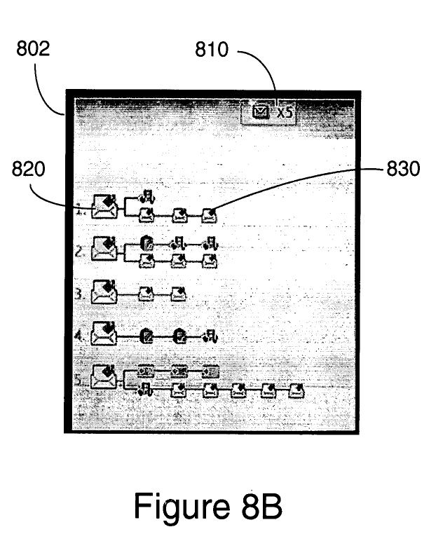

The visualization component works in two levels: a system level and an object level. The system level visualization component is merely an indicator displaying that new relations have been discovered. It may be interactive, providing the user with a shortcut to the discovered new relation. FIG. 8A illustrates an example indicator 810 on a display 802 of a terminal device 800 in accordance with at least one aspect of the present invention as described below. The object level visualization component displays all relation information for each object individually. It provides access to all the other objects that are part of the relation. It also includes advanced views to the relations that display, e.g., graphs. In an object level visualization component, the user is able to select a relation and manipulate it, e.g., remove a relation, or verifying it (i.e., indicating that the discovered relation is rational). An extended system level visualization component can be used when a terminal device is in an idle state. The relation information can be displayed as a screen saver, thus containing much more information compared to a mere indicator.

The visualization component may be interactive. In addition to acting as information providers, visualization components may act as navigation guidelines to the displayed information. The implementation requires that the relations are stored so that they can be retrieved later. As such, a user interface is needed to provide access to the relations. A system-level relation indicator may be displayed as an unobtrusive icon 810 on the screen 802, not unlike the battery and field strength indicators in many terminal devices 800. FIGS. 8A and 8B illustrate examples of such indicators 810. The icon 810 may show that there are new relations discovered and that they relate to messages. The icon 810 also displays the amount and/or type of new relations discovered. The icon's visual appearance may change according to the media types that are included in the relation. If there are several different media types involved, the icon 810 may provide a combination of them. Further, the icon 810 may be partially transparent. The icon's appearance may become more transparent when time passes without the user checking the relation. Once the user has checked for the new discovered relations, the system-level indicator may be removed from the screen until new relations are discovered.

The user may navigate to the system level icon 810 and click on the icon 810 to open a view that displays the discovered relations in detail in the object level view as shown in FIG. 8B. The information may be displayed for each media item separately. The user can see the relations 830 related to any objects 820, as well as the amount of them. Further, she can see the media types. The user is able to browse the relations 830, to expand the view, and to select another media item as the root object. As shown in FIG. 8B, the user is able to select and manipulate either complete relation chains or single media items. As an example, the user may choose an item 830 to open, she may select a complete relation chain to remove or verify it, or she may select one or more objects and add or remove them from a relation chain.

One or more aspects of the invention may be embodied in computer-executable instructions, such as in one or more program modules, executed by one or more computers, set top boxes, mobile terminals, or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like.

Although the invention has been defined using the appended claims, these claims are exemplary in that the invention may be intended to include the elements and steps described herein in any combination or sub combination. Accordingly, there are any number of alternative combinations for defining the invention, which incorporate one or more elements from the specification, including the description, claims, and drawings, in various combinations or sub combinations. It will be apparent to those skilled in the relevant technology, in light of the present specification, that alternate combinations of aspects of the invention, either alone or in combination with one or more elements or steps defined herein, may be utilized as modifications or alterations of the invention or as part of the invention. It may be intended that the written description of the invention contained herein covers all such modifications and alterations.

We claim:

1. A method for managing metadata, the method comprising steps of:
receiving a request from an application to access a metadata attribute corresponding to a piece of content;
determining whether the application is authorized to access the metadata attribute;
retrieving the metadata attribute upon determining that the application is authorized to access the metadata attribute; and
transmitting the metadata attribute to the application.

2. The method of claim 1, wherein the step of retrieving includes steps of:
accessing a metadata storage medium;
searching the metadata storage medium for the metadata attribute; and
identifying the metadata attribute.

3. The method of claim 2, wherein the step of retrieving includes a step of decrypting the metadata attribute.

4. The method of claim 1, further comprising steps of:
determining whether the metadata attribute has been modified; and
automatically storing the modified metadata attribute.

5. The method of claim 4, wherein upon determining the metadata attribute has been modified, the method includes a step of modifying a second metadata attribute to indicate the modified first metadata attribute.

6. The method of claim 4, wherein the step of automatically storing includes automatically storing the modified metadata attribute in a device external to the application.

7. The method of claim 1, wherein the metadata attribute is stored in the metadata storage medium separate from the piece of content.

8. The method of claim 1, wherein the request from the application to access the metadata attribute is a request to modify the metadata attribute.

9. The method of claim 8, further comprising a step of modifying the metadata attribute in response to the request from the application.

10. The method of claim 1, wherein the step of determining includes determining an access right to modify the metadata attribute.

11. The method of claim 10, wherein the access right is an indication of applications authorized to modify the metadata attribute.

12. The method of claim 1, wherein the metadata attribute is a private metadata attribute.

13. A computer-readable medium storing computer-executable instructions for performing the steps recited in claim 1.

14. A device, comprising:
an authorization system configured to determine whether an application is authorized to access a metadata attribute corresponding to a content object;
a metadata engine configured to receive requests to access metadata attributes from the authorization system and to transmit metadata attributes to the authorization system;
a metadata storage system configured to store metadata attributes corresponding to content objects; and
a media database configured to store content objects.

15. The device of claim 14, further comprising a harvester configured to analyze the content object to obtain the metadata attribute.

16. The device of claim 14, further comprising a filter configured to extract the metadata attribute from the content object.

17. The device of claim 14, further comprising a search tool configured to search the metadata storage system for the metadata attribute.

18. The device of claim 14, wherein the media database is external to the metadata storage system.

19. The device of claim 14, wherein the authorization system, the metadata engine, the metadata storage system, and the media database are software components.

20. The device of claim 14, wherein the device is a terminal device of a user.

21. The device of claim 14, wherein the device is a server.

22. A user interface in a computer for reviewing a relation to a content object, comprising:
a first portion configured to indicate the existence of at least one new relation to a content object; and
a second portion configured to indicate a type of the at least one new relation.

23. The user interface of claim 22, further comprising a third portion configured to indicate the number of the at least one new relation.

24. The user interface of claim 22, further comprising a third portion configured to indicate a freshness of the at least one new relation.

25. The user interface of claim 22, wherein the first portion is further configured to receive a user input to open the at least one new relation.

26. The user interface of claim 22, wherein the type of at least one new relation is at least one of: a media file and a text file.

27. A system for managing metadata, the system comprising:
a terminal device including an application configured to request access to metadata attributes corresponding to content objects;
an authorization subsystem configured to determine whether the application is authorized to access a metadata attribute corresponding to a content object;
a metadata engine configured to receive requests to access metadata attributes from the authorization system and to transmit metadata attributes to the authorization system;
a metadata storage subsystem configured to store metadata attributes corresponding to content objects; and
a media storage subsystem configured to store content objects.

28. The system of claim 27, wherein the terminal device includes the authorization subsystem.

29. The system of claim 27, wherein the metadata storage subsystem and the media storage subsystem are stored separately in a common storage subsystem.

30. The system of claim 27, further comprising a harvester application configured to analyze the content object to obtain the metadata attribute.

31. The system of claim 27, further comprising a filter configured to extract the metadata attribute from the content object.

32. The system of claim 27, further comprising a search tool configured to search the metadata storage subsystem for the metadata attribute.
